(19) United States
(12) Patent Application Publication
(10) Pub. No.: US 2003/0236943 A1
(43) Pub. Date: Dec. 25, 2003

(54) Method and systems for flyby raid parity generation

(76) Inventor: William P. Delaney, Wichita, KS (US)

Correspondence Address: LSI LOGIC CORPORATION, 1621 BARBER LANE, MS: D-106 LEGAL, MILPITAS, CA, 95035, US

(21) Appl. No.: 10/178,824

(22) Filed: Jun. 24, 2002

(51) Int. Cl. G06F 12/16; G06F 12/00

(52) U.S. Cl. 711/114; 711/113

(57) ABSTRACT

Methods and structure for improved RAID storage subsystem performance in high bandwidth, a full stripe operating modes. The invention provides for flyby parity generation within the RAID storage controller for use of a high-speed memory buffer dedicated to XOR parity generation. As full stripe host supplied write data is transferred via a high-speed I/O channels from a host system to a data cache memory within the storage controller, flyby XOR parity generation using the high-speed XOR buffer generates the corresponding parity block. The generated parity block is then transferred to a corresponding location in data cache memory without the need for reading host supplied data blocks solely for purposes of generating parity.

### RELATED PATENTS

This patent application is related to co-pending, commonly owned patent application Ser. No. 10/076,681 filed on Feb. 14, 2002 and entitled METHODS AND APPARATUS FOR LOADING CRC VALUES INTO A CRC CACHE IN A STORAGE CONTROLLER which is hereby incorporated by reference.

### BACKGROUND OF THE INVENTION

1. Field of the Invention

The invention relates to RAID storage management techniques and controllers and more specifically relates to methods and structures for flyby parity generation in parallel with reception of data from an attached host system. Such a structure and method is beneficially applied to a RAID level 5 storage subsystem to improve system throughput by reducing memory bandwidth utilization on the bus used to transfer data into and out of the controller's cache memory.

2. Discussion of Related Art

In large enterprise computing storage applications, and other high reliability computer storage applications, it is common to utilize RAID storage management techniques to improve the performance and reliability of a data storage subsystem. In general, as is known in the art, RAID storage subsystems generate and store redundant information along with host system supplied data to enhance the reliability of the storage subsystem. A RAID storage subsystem utilizes a plurality of disk drives in such a manner that if any single disk drive fails within the storage subsystem the redundant information generated and stored in other disk drives of the storage subsystem may be used to regenerate missing information. In fact, the redundant information permits continuing operation of the storage subsystem despite the loss of any particular disk drive.

A number of RAID storage management techniques (each referred to as a “level”) are known in the art to enhance redundancy while balancing enhanced performance with the cost of additional storage space and other resources within the storage subsystem. A common RAID storage management technique referred to as a RAID level 5 distributes or “stripes” host supplied data and redundant data to be stored in the subsystem over a plurality of disk drives. At least one additional disk drive is used for additional capacity to store exclusive OR (“XOR”) parity information associated with corresponding blocks of information on other disk drives of the storage subsystem. The distributed blocks of user data and corresponding blocks of XOR parity information are collectively referred to as a “stripe” or “physical stripe.”

To improve subsystem performance, it is broadly known in the art to utilize cache memory structures within a storage controller controlling operation of the RAID storage subsystem. The cache memory is used to store information received from a host computer to there await transfer (“posting”) from the cache memory to the disk storage of the storage subsystem. By recording host supplied data in the cache memory, the storage subsystem may complete the host request without delaying the host computer waiting for complete posting of the data from cache memory to the disk drives of the storage subsystem. As presently practiced in the art subsequent post-processing after receipt of such host supplied information generates the corresponding parity information and posts all received stripes (blocks of host supplied data plus corresponding parity blocks generated by storage controller) to the permanent storage of the disk drives.

Present techniques receive host system supplied data via a communications interface and write received data into the cache memory as the data is received typically using direct memory access (“DMA”) techniques within a host channel interface component of the controller. The data just written to cache memory is then read by the RAID controller for purposes of generating corresponding parity information. The generated parity information is then written to cache memory. At some later point in time, when information is to be posted to the disk drives, the host supplied data and controller generated parity are read from the cache memory and transferred to the disk drives of the storage subsystem.

A full stripe in a RAID level 5 subsystem typically comprises N data blocks of host supplied data plus one corresponding parity block generated by the RAID controller. Further, it is common that each “block” of data comprises M physical sectors of a disk drive—often referred to as a “blocking factor.” Such blocking factors are common in the art to improve overall subsystem performance by transferring data in block sizes optimal to the subsystem design. Consequently, the total amount of host supplied data associated with a “stripe” of the RAID storage subsystem is N*M sectors of data.

Based on the above description of data transfer and parity generation, a write of a full stripe comprising N*M sectors of host supplied data requires 3*N*M+2*M sectors worth of data to traverse the data cache memory bus within the storage controller. In other words, N*M sectors of user data are first written to the data cache, read from the data cache to compute parity, then later read again from the data cache to be transferred to disk storage. Furthermore, the generated parity is first written to the data cache after being generated and then read back from cache when subsequently transferred from the data cache to disk storage. Thus, in order to sustain full bandwidth performance on the I/O channel that transfers data from host systems to the RAID storage subsystem, the RAID storage subsystem controller's data cache memory must possess bandwidth capabilities that are (3+2/N) times greater than that of the I/O channels used for host communication. For example, in a “4+1” RAID level 5 storage subsystem configuration (a subsystem having 4 blocks of data plus 1 corresponding parity block distributed over 5 disk drives), the data cache memory bus must have 3.5 (i.e., 3+2/4) times of the bandwidth of the host communication I/O channels in order to sustain full I/O channel capacity. Or, phrased differently, the maximum aggregate transfer rate over the host I/O channels is always limited to at most 1/3.5 of the data cache memory bandwidth.

As recent developments continue to enhance the available bandwidth for I/O channel host communications, the I/O bus bandwidth is beginning to overshadow corresponding improvements in DRAM memory technology commonly used for the data cache. This 3.5× performance factor is a characteristic of RAID level 5 storage subsystem solutions that makes this performance issue difficult to resolve. One possible, but costly, solution is to utilize faster RAM technology, such as static RAM (“SRAM”) devices, to improve the available memory bandwidth of the cache memory structure. Given the large data cache capacities generally desirable in high-capacity, high-performance RAID level 5 storage subsystems, such a costly solution is impractical.

It is evident from the above discussion that a need exists for an improved architecture to enable full utilization of higher speed I/O channel capabilities for host communication while maintaining low cost in the RAID storage subsystem controller design.

### SUMMARY OF THE INVENTION

The present invention solves the above and other problems, thereby advancing the state of the useful arts, by providing methods and associated structure for performing flyby parity generation as data is initially transferred from a host system via an I/O channel into data cache memory. More specifically, the present invention provides a small, high-speed SRAM and bus snooping features to transfer host supplied data into data cache memory while substantially simultaneously generating associated parity information in the high-speed SRAM components. As a first block of a full stripe is transferred from the host system to the controller's cache memory, the data is simultaneously copied to the DRAM comprising the data cache memory and to the SRAM used for XOR parity generation. As each subsequent block of the full stripe is transferred via the high-speed I/O channel from host system, each additional block is XORd with the previous values stored in the SRAM buffer and simultaneously stored in its appropriate position in the data cache memory. When the full stripe has completed transfer from the host system, the SRAM XOR parity buffer contains the completed, generated XOR parity block corresponding to the full stripe. The generated XOR parity block is then copied to an appropriate location in data cache memory to there accompany the data blocks of the stripe. This architecture eliminates one additional transfer as described above wherein host supplied data blocks of a full stripe are read back from data cache memory after being transferred thereto solely for purposes of generating a corresponding XOR parity block. A RAID subsystem controller's data cache memory, in accordance with the one embodiment of the present invention, must possess bandwidth capabilities that are only (2+2/N) times greater than that of the host I/O channels used for host system communication. This is a substantial improvement over the prior architectures that required cache memory bandwidth (3+2/N) time greater than that of the host I/O channels.

Still more specifically, methods and structure of the present invention overlap special memory bus cycles for the SRAM XOR parity buffer with the standard bus cycles required for transferring host supplied data initially into the data cache memory. A first bus within the RAID storage controller may be used for transfers between the host system channel interface and the cache memory. A second bus is used to transfer information in the higher speed parity buffer in parallel with the transfer between the host system and the cache memory. This architecture permits rapid XOR parity generation without the need for additional read memory cycles from the lower speed data cache memory.

The architecture is useful only for full stripe write operations because it presumes that there is no need to read older data to generate the complete parity block. Rather, all data needed to compute the parity block is transferred as a full stripe of write data from the host channel interface. Such full stripe write requests from a host system are common in many high bandwidth storage applications. For other modes of operation such as random I/O workloads where full stripe operations are not performed or are less frequent, standard XOR parity generation as presently practiced in the art may be performed.

A first feature of the invention therefore provides a method in a RAID storage subsystem comprising a plurality of disk drives coupled to a RAID storage controller having a cache memory, the method for RAID parity generation comprising the steps of: writing user data received by the controller from a host system coupled to the controller to the cache memory; and generating parity information corresponding to the user data in a parity buffer associated with the controller substantially in parallel with the transfer of the user data.

Another aspect of the invention further provides for writing the generated parity information to the cache memory.

Another aspect of the invention further provides that the step of generating further comprises: detecting memory transactions involving the cache memory generated by the step of writing; and generating corresponding transactions in the parity buffer to generate the parity information.

Another aspect of the invention further provides that the step of writing comprises the steps of: writing a first block of the user data to the cache memory; and writing subsequent blocks of the user data to the cache memory, and that the step of generating corresponding transactions comprises the steps of: generating write transactions to copy the first block to the parity buffer substantially in parallel with the writing of the first block to the cache memory; and generating XOR transactions to accumulate parity values in the parity buffer substantially in parallel with the writing of the subsequent blocks to the cache memory.

Another aspect of the invention further provides that the step of writing comprises the steps of: writing blocks of the user data to the cache memory, and that the step of generating corresponding transactions comprises the steps of: clearing the parity buffer prior to writing the first block of the blocks of user data; and generating XOR transactions to accumulate parity values in the parity buffer substantially in parallel with the writing of the user data blocks to the cache memory.

Another aspect of the invention further provides that the memory transactions include an address field and that the step of detecting comprises the step of: deriving a location in the parity buffer from the address field of each detected memory transaction, and that the step of generating the corresponding transactions comprises the step of: generating the corresponding transactions to involve the derived locations in the parity memory.

Another aspect of the invention further provides that the step of writing comprises: generating memory transactions on a first bus to transfer the user data to the cache memory such that each memory transaction includes an address field identifying a location in the cache memory, and that the step of generating corresponding transactions comprises: deriving a corresponding address in the parity buffer from the address field in each memory transaction; and generating corresponding transactions on a second bus to generate the parity information in the parity buffer such that each corresponding transaction involves the derived address.

Another feature of the invention provides for a RAID storage controller comprising: an interface channel for receiving user data from a host system; a cache memory for storing user data received over the interface channel; a first bus coupling the interface channel and the cache memory for transferring the user data therebetween; a parity buffer; a parity generator coupled to the first bus for generating parity information in the parity buffer; and a second bus coupling the parity generator to the parity buffer and to the first bus, such that the parity generator is operable to generate the parity information corresponding to the user data substantially in parallel with the transfer of the user data from the interface channel to the cache memory via the first bus.

Another aspect of the invention further provides that the controller is operable to copy the parity information from the parity buffer to the cache memory following completion of the generation thereof by the parity generator.

Another aspect of the invention further provides that the parity generator includes: a bus monitor to detect the memory transactions on the first bus such that the parity generator generates the parity information in accordance with each detected memory transaction.

Another aspect of the invention further provides that the parity buffer comprises memory having a first bandwidth and that the ache memory comprises memory have a second bandwidth and that the first bandwidth is higher than the second bandwidth.

Another aspect of the invention further provides that the parity buffer comprises SRAM memory components and that the cache memory comprises DRAM memory components.

Another aspect of the invention further provides that the first bus is a PCI bus.

Another feature of the invention provides a RAID storage subsystem comprising: a plurality of disk drives; and a RAID storage controller coupled to the plurality of disk drives such that the controller comprises: cache memory for storage of user data received from a host system connected to the controller; a parity buffer; and a flyby parity generator coupled to the cache memory and coupled to the parity buffer for generating parity information corresponding to the user data substantially in parallel with storing of the user data in the cache memory.

Another aspect of the invention further provides that the RAID controller further comprises: a host channel interface for receiving the user data from a host system; a first bus coupling the host channel interface to the cache memory; and a second bus coupling the parity generator to the parity buffer, such that the parity generator is coupled to the first bus to monitor the transfer of user data from the host channel interface to the cache memory for purposes of generating the parity information.

### BRIEF DESCRIPTION OF THE DRAWINGS

FIG. 1 is a block diagram of a RAID storage subsystem having flyby parity generation in accordance with the present invention.

FIG. 2 is a flowchart of a method of the present invention for performing flyby parity generation in a RAID storage subsystem.

FIG. 3 is an exemplary timing diagram depicting flyby parity generation in accordance with the present invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

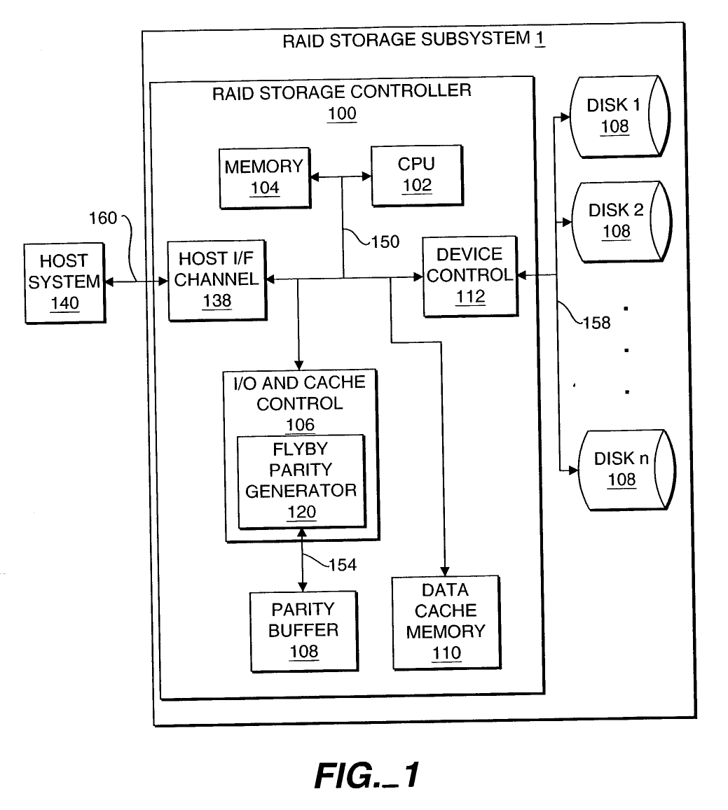

FIG. 1 is a block diagram of a RAID storage subsystem 1 adapted for flyby parity generation in accordance with the present invention. In particular, RAID storage subsystem 1 includes RAID storage controller 100 coupled via path 158 to a plurality of disk drives 108 containing host system generated data and associated RAID redundancy information (i.e., XOR parity information). RAID storage controller 100 is also coupled via bus 160 to host system 140. Those of ordinary skill in the art will readily recognize that any number of disk drives may be associated with such a subsystem. Further, path 158 may be any of several well known interface media and protocols for coupling RAID storage controller 100 to a plurality of disk drives 108. For example, path 158 may be a SCSI parallel interface bus, a Fibre Channel interface or other similar interface media and associated protocols. Further, those of ordinary skill in the art will recognize that bus 160 may be any of several well known commercially available bus structures including, for example, SCSI parallel interface bus, Fibre Channel, network communications including Ethernet, or any of several similar communication media and associated protocols. Further, those of ordinary skill in the art will readily recognize that host system 140 may represent a plurality of such host systems coupled to the RAID storage subsystem 1 via bus 160. Depending on the particular communication medium and protocols selected for path 160, a plurality of such host systems 140 may be concurrently coupled to, and in communications. with the RAID storage subsystem 1.

RAID storage controller 100 may preferably include a general-purpose processor CPU 102 suitably programmed to perform appropriate RAID storage management for storage and retrieval of information on disk drives 108. CPU 102 may preferably fetch programmed instructions from memory 104 and use other portions of memory 104 for storage and retrieval of dynamic variables and information associated with the RAID storage management techniques applied within the RAID storage controller 100. Those skilled in the art will recognize numerous commercially available general-purpose processors that may be used for such purposes and numerous memory architectures and components for such storage purposes.

CPU 102 and memory 104 along with other components within RAID storage controller 100 preferably communicate via bus 150. Those skilled in the art will readily recognize that multiple such buses may be incorporated within a high-performance storage controller architecture to segregate information exchange among the various components and thereby optimized utilization of bandwidth on each associated bus structure. For purposes of presentation herein, bus 150 represents all such architectures including a single common bus and multiple buses for exchange of information among the various components.

Host channel interface 138 may be coupled through bus 150 to other components within RAID storage controller 100 for purposes of controlling and coordinating interaction with the host system 140 via bus 160. In like manner, device control 112 may be coupled through bus 150 to other components within RAID storage controller 100 for purposes of controlling and coordinating interaction with the plurality of disk drives 108 within RAID storage subsystem 1. Device control 112 and host channel interface 138 are often referred to as I/O coprocessors or intelligent I/O coprocessors (“IOP”). Such I/O coprocessors often possess substantial processing capabilities including, for example, direct memory access capability to memory components within the RAID storage controller 100.

Control element 106 is also coupled to bus 150 to provide coordination and control of access to data cache memory 110 by the various components within RAID storage controller 100. In general, under direction of CPU 102, host channel interface 138 may utilize direct memory access techniques to store and retrieve data in data cache memory 110 associated with the processing of host system 140 generated I/O requests. In particular, host channel interface 138 may utilize direct memory access techniques to write host supplied data into data cache memory 110 for temporary storage before eventually being posted to disk drives 108 by subsequent postprocessing by CPU 102. In like manner, device control I/O processor 112 may utilize direct memory access techniques to store and retrieve information in cache memory 110 associated with low-level disk operations performed on disk drives 108. Control element 106 may coordinate such access to the cache memory 110. For simplicity, data cache memory 110 is shown directly coupled to bus 150 along with other components of the RAID storage controller 100. As is known in the art, it may be preferable for data cache memory to be directly coupled to control element 106 via a high-speed, dedicated, memory bus structure. Regardless of whether host channel interface 138 and data cache memory 110 are directly coupled through a common bus or indirectly coupled through control element 106 and a high-speed, dedicated memory bus, host channel interface 138 may be viewed as directing data into data cache memory 110 through direct memory access techniques in response to processing of host generated I/O requests.

Those skilled in the art will readily recognize that bus 150 may be any of several well known, commercially available bus structures including, for example, PCI and AMBA AHB bus structures as well as other proprietary, processor specific or application specific bus structures. As relates to the present invention, it is presumed only that bus structure 150 may be monitored for purposes of flyby parity generation as discussed further herein below.

Control element 106 may preferably include flyby parity generator 120 for generating parity information substantially in parallel with transfers of data between host channel interface 138 and data cache memory 110. As noted above, flyby parity generator 112 preferably monitors bus transactions on bus 150 utilized to transfer data between host channel interface 138 and data cache memory 110. Further as noted above, such transfers may be via direct bus interconnect between host channel interface 138 and data cache memory 110 through bus 150 as depicted in FIG. 1 or may be directed from host channel interface 138 through control element 106 and then forwarded through a high-speed, dedicated memory bus to data cache memory 110.

Flyby parity generator 120 monitors bus transactions on bus 150 and generates appropriate parity information in parallel with the detected transfers to cache memory. The parity information so generated is stored temporarily in parity buffer 108 coupled to flyby parity generator 120 via path 154. Flyby parity generator 120 preferably connects to parity buffer 108 via a second, independent bus structure 154 so as to permit overlap of transactions in parity buffer 108 with associated data transfers into cache memory 110 by host channel interface 138. Those of ordinary skill in the art will readily recognize numerous bus structures that may be used for path 154 including, dedicated memory bus architectures and standard commercial interface buses including, for example, PCI.

As noted above, flyby parity generator 120 preferably monitors bus transactions on bus 150 to detect transfers of data from host channel interface 138 to data cache memory 110. Flyby parity generator 120 therefore inherently includes a bus monitoring capability to monitor such bus transactions on bus 150.

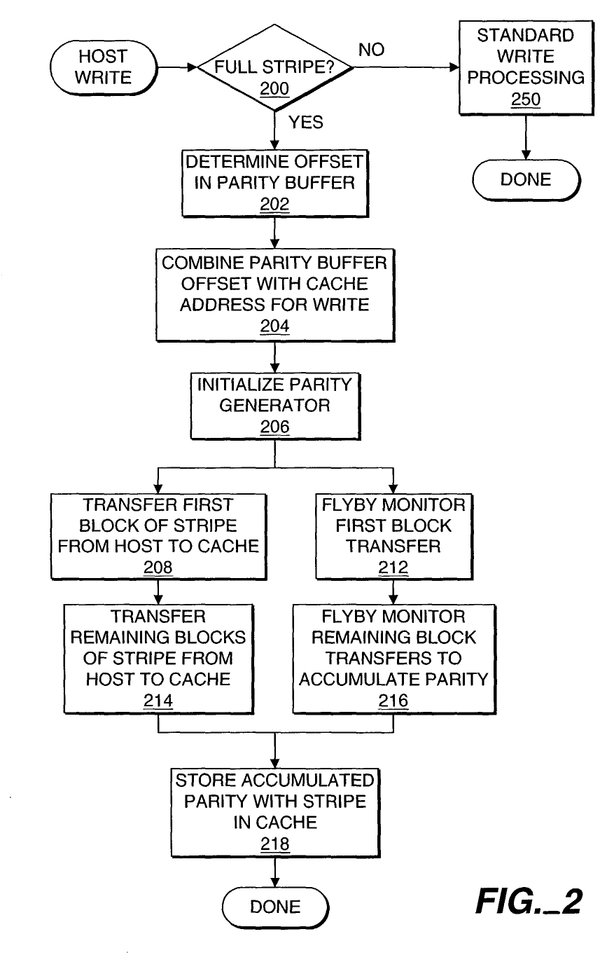

FIG. 2 is a flowchart describing a method of operation for performing flyby parity generation in a system such as shown in FIG. 1 and described above in accordance with the present invention. As noted above, features of the present invention are most useful when the host system is generating full stripe write operations as distinct from partial stripe write operations. Such full stripe write operations are common in many high throughput data storage applications including, for example, video stream capture and other multimedia capture applications.

Element 200 of FIG. 2 first determines whether the host write operation is requesting the write of a full stripe. If not, processing continues at element 250 to perform standard write processing including parity generation and updating in accordance with well known standard RAID processing techniques.

If element 200 determines that the host generated write request is requesting a full stripe write, element 202 next determines an offset in the parity buffer for a location to be used for parity generation for this associated stripe. In a preferred embodiment, the parity buffer may be as small as one block size corresponding to the blocks of user data supplied in the full stripe write or may be configured with the capacity for multiple blocks. Where configured for multiple blocks, a next full stripe write may be performed including flyby parity generation while previously generated parity information corresponding to earlier full stripe writes is being copied from the parity buffer to the cache memory. Where the parity buffer is configured to support multiple blocks of parity information, the parity generation components of the cache controller and parity engine may determine an offset for an unused block within the parity buffer to be used for generation of a next parity block. Element 204 then preferably combines the determined offset in the parity buffer with addresses in cache memory to be used for transfer of the host supplied stripe data to cache memory. Element 202 and 204 therefore preferably generate an address to be used for the DMA transfer of full stripe data to cache memory wherein a portion of the address is also used to trigger operation of the flyby parity generation components of the controller. Where a parity buffer is configured for no more than one block of parity information, the steps of elements 202 and 204 may be bypassed. Element 206 then initializes the parity generation components of the RAID controller to be prepared for flyby generation as blocks of the stripe data are transferred from the host channel interface to the cache memory.

Those of ordinary skill in the art will recognize that combining the parity buffer offset with the cache memory address to be used for writing stripe data is but one design choice for implementing addressing into the parity buffer as flyby data is detected. Numerous equivalent techniques will be readily apparent to those of ordinary skill in the art. For example, the flyby parity generator could be programmed to recognize ranges of addresses corresponding to the stripe being written to cache memory and programmed with a base address for the parity buffer range to be used to compute the corresponding parity. Such programmed values may be stored as registers within the parity generator for use in the flyby parity generation. Fundamentally, the flyby parity generator needs to recognize transactions on the first bus that represent transfers from the host channel interface to the cache memory and needs to translate such recognized transactions to corresponding locations in the parity buffer where XOR parity values are accumulated. Numerous equivalent design choices for implementing this feature will be readily apparent to those of ordinary skill in the art.

Once the flyby parity generator is so initialized, transfer of the stripe data and substantially parallel generation of parity information then commences by operation of elements 208 and 212. In particular, elements 208 and 212 are preferably operable substantially in parallel to transfer the first block of host supplied stripe data from the host channel interface to cache memory. Specifically, element 208 performs the desired transfer of the first block the stripe data while element 212, operating substantially in parallel with element 208, generates parity information by monitoring the data transfer over the first bus between the host channel interface and cache memory. Element 212 therefore generates parity information in the parity buffer corresponding to the transfer of the first block of stripe data.

Following transfer of the first block of a full stripe of data, elements 214 and 216 are likewise operable substantially in parallel to transfer remaining blocks of stripe data from the host channel interface to the cache memory while generating parity information. Specifically, element 214 transfers remaining blocks of the full stripe write request from the host channel interface to the cache memory. Element 216 is operable substantially in parallel with element 214 to generate parity information corresponding to the remaining blocks of the full stripe write.

Element 218 is lastly operable to store the accumulated parity information generated and stored in the parity buffer into the cache memory at an appropriate location corresponding to the full stripe data transferred by elements 208 and 214. As noted above, operation of element 218 may preferably overlap with flyby generation of parity information for a next full stripe write when the parity buffer is adapted to store multiple blocks of parity information. Where the parity buffer is configured to store only a single block of parity information, operation of element 218 preferably completes before a next full stripe write operations is commenced by host request.

As described herein above, elements 208 and 212 are operable substantially in parallel to transfer the first block of a full stripe write request as distinct from the operation of elements 214 and 216 to transfer and generate parity for remaining blocks of the full stripe write. Parity generation for subsequent blocks of the full stripe generally entails reading a previously stored XOR parity sum value from the parity buffer for each transferred unit of data, XORing the value of the new data unit transferred, and storing the new XOR result back into the parity buffer to thereby accumulate a parity value. Those of ordinary skill in the art will recognize that generation of parity information for the first block transferred is different than generation of parity information for subsequent blocks in that there is not initially an accumulating XOR parity sum in the parity buffer. Generation of parity information for the first block of a stripe being transferred may therefore be performed in at least one of two manners. First, generation of parity information for the first block of a stripe may simply comprise copying the data transferred into the parity buffer (in a flyby manner) as discussed above. Subsequent data blocks are then XOR summed into the parity buffer to continue accumulation of parity information for the entire stripe. As an alternative, the parity buffer may be first cleared to all zero values prior to transfer of any blocks of the stripe. Each data block of the full stripe, including the first block, may then be XOR summed into the parity buffer. All blocks of the data stripe, including the first block, are therefore XOR summed into the parity buffer. Such a clearing of the parity buffer may be achieved by any of several equivalent techniques readily apparent to those of ordinary skill in the art. In both exemplary embodiments, the method of FIG. 2 is generally operable to assure substantial overlap of the transfer of data from the host channel interface to the cache memory with corresponding parity generation into the parity buffer. The parity generation generally monitors the data transfers on a first bus and preferably generates required transactions for parity generation on a second, independent bus to thereby allow overlap of the two transactions on distinct buses. The parity transactions involve reads of the parity buffer memory followed by corresponding writes of the same locations to update the accumulating XOR parity sum.

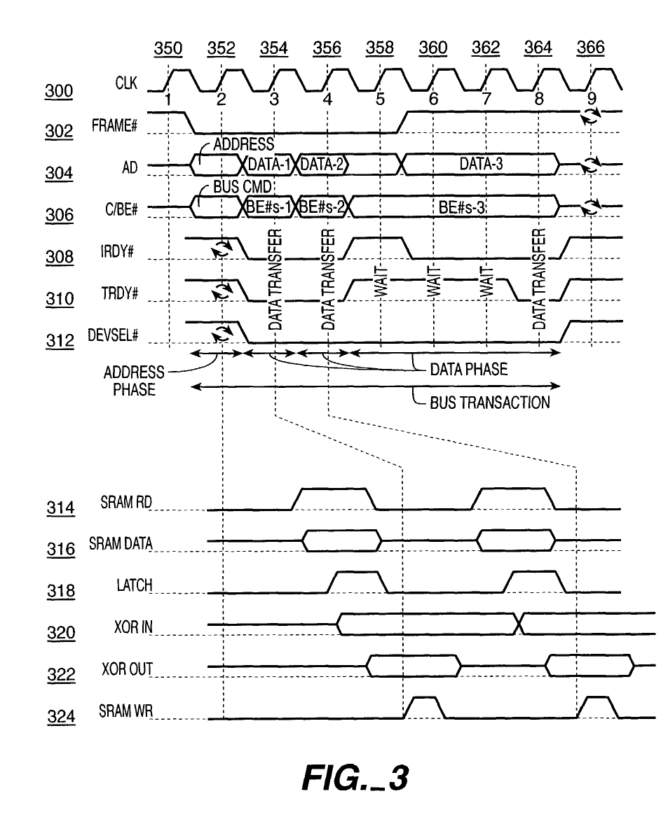

FIG. 3 is a sample signal timing diagram describing signal timings of one exemplary embodiment for achieving the desired overlap between data transferred to the cache memory and associated parity generation. In one exemplary embodiment of the present invention, a PCI bus is used as a first bus for transferring data from the host channel interface to the cache memory in response to a host initiated write request. When a full stripe is to be written by the host channel interface, data for each block is written from the host channel interface to cache memory typically using a direct memory access (DMA) transfer via the PCI. In FIG. 3, signals 300 through 312 are typical signals used in a PCI interface to apply data in a burst transfer from an initiator device to a target device. In such an exemplary transfer, the host channel interface would be an initiator device (assuming it to be capable of initiating master transfers on a PCI bus) and the cache memory would be the target of such a transfer (typically through a memory controller such as the cache controller 106 depicted in FIG. 1). Time indicators 350 through 366 are marked along the top edge of FIG. 3 to indicate each clock period of the exemplary PCI bus transfer.

At time indicator 352, an address signal is applied to address/data signals 304 to indicate the desired address for the start of the burst transfer. As noted above, in a preferred embodiment, the address may encode both an offset within the cache memory and an offset within the parity buffer for purposes of the flyby parity generator. Command/byte-enable signals 306 provided the desired burst write command at time indicator 352 to initiate the burst write data transfer. The initiator device then asserts its initiator ready signal 308 at time indicator 354 and the target device responds with its ready signal 310. The first unit of information of the burst transfer (typically a “word” of either 4 or 8 bytes) is therefore ready for storage by the target of the transfer at time indicator 354. A second unit of information is next available at time indicator 356. Such a burst transfer continues using standard handshake signals of the exemplary PCI bus. Those of ordinary skill in the art will readily recognize signals 300 through 312 as typical signals in a PCI burst transfer exchange. Such transfers on a PCI bus system are well known to those of ordinary skill in the art.

The bottom half of FIG. 3 provides a blowup of two of the data transfers shown in FIG. 3—specifically the time period from indicator 352 through 354 and the time period from indicator 354 through 356. Signals 314 through 324 represent typical signals useful in a static RAM implementation of the parity buffer. These signals represent a second bus structure independent of the first bus structure (the PCI structure used for DMA transfers from the host channel interface to the cache memory). As noted above, it is preferable that the parity buffer utilizes memory having a faster cycle time than that used for the cache memory. Typically DRAM memory components are used for the cache memory to reduce the cost of the substantial size cache. By contrast, the parity buffer is substantially smaller and may preferably utilize faster static RAM technology. Those of ordinary skill in the art will recognize a variety of memory components that may be utilized for both the cache memory and the parity buffer.

To accumulate an XOR parity value, the memory location in static RAM indicated by an offset encoded in the detected transfer to cache memory is first read as indicated by signal 314 to acquire the current data value at that address. The data at the addressed static RAM offset is made ready by the SRAM as indicated by SRAM data signal 316. The value so read is then preferably latched in a holding register as indicated by signal 318 and applied as a first input to the XOR function within the parity generator. The second value applied to the XOR function within the parity generator is the present data value on the PCI bus as indicated by signal 304 at time indicator 354 as described above. Signal 320 therefore indicates the readiness of both input values for the XOR function within the parity generator. Signal 322 then indicates availability of the output of the XOR function within the parity generator. Signal 324 then enables the output of the XOR function to be applied to the currently addressed location of the SRAM using a write function to record the newly accumulated XOR parity value for the corresponding transferred unit of information. A second cycle is then shown corresponding to the next transferred unit of information performed in the PCI sequences described above. Those of ordinary skill in the art will recognize that the sequence continues for each transfer unit of the block thus generating the current accumulated XOR parity value for each transfer unit through a first block of the full stripe write. The sequence then repeats for each block of the full stripe write as discussed above with respect to FIG. 2. As noted above, alternative embodiments will be readily apparent to those of ordinary skill in the art to start the XOR parity accumulation for the first block of the full stripe transfer. The first block may be handled specially in that its values may be simply copied to the parity buffer since there is no previous accumulated sum with which to exclusive OR. Or, as above, the parity buffer may be initialized before any data transfer commences for a full stripe. By clearing the parity buffer block to all zeros prior to transfer of the first block of the stripe, the first stripe may simply be XOR accumulated into the parity buffer as all other blocks of the stripe.

When the parity value has been computed for each transfer unit for all blocks, the accumulated parity information is then transferred from the parity buffer to a location in the cache memory associated with the full stripe in accordance with standard memory transfer functions using the PCI bus.

Those of ordinary skill in the art will readily recognize that FIG. 3 is intended merely as representative of a typical transfer sequence using a PCI bus as a first transfer bus between the host channel interface and cache memory and using a second high-speed memory bus for the XOR parity generation function within the SRAM of the parity buffer. Numerous equivalent signal timings will be readily apparent to those of ordinary skill in the art as appropriate for the particular bus architecture selected for both the first and second transfer buses.

While the invention has been illustrated and described in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

What is claimed is:

1. In a RAID storage subsystem comprising a plurality of disk drives coupled to a RAID storage controller having a cache memory, a method for RAID parity generation comprising the steps of:
writing user data received by said controller from a host system coupled to said controller to said cache memory; and
generating parity information corresponding to said user data in a parity buffer associated with said controller substantially in parallel with the transfer of said user data.

2. The method of claim 1 further comprising:
writing the generated parity information to said cache memory.

3. The method of claim 1 wherein the step of generating further comprises:
detecting memory transactions involving said cache memory generated by the step of writing; and
generating corresponding transactions in said parity buffer to generate said parity information.

4. The method of claim 3
wherein the step of writing comprises the steps of:
writing a first block of said user data to said cache memory; and
writing subsequent blocks of said user data to said cache memory, and
wherein the step of generating corresponding transactions comprises the steps of:
generating write transactions to copy said first block to said parity buffer substantially in parallel with the writing of said first block to said cache memory; and
generating XOR transactions to accumulate parity values in said parity buffer substantially in parallel with the writing of said subsequent blocks to said cache memory.

5. The method of claim 3
wherein the step of writing comprises the steps of:
writing blocks of said user data to said cache memory, and
wherein the step of generating corresponding transactions comprises the steps of:
clearing said parity buffer prior to writing the first block of said blocks of user data; and
generating XOR transactions to accumulate parity values in said parity buffer substantially in parallel with the writing of said user data blocks to said cache memory.

6. The method of claim 3 wherein said memory transactions include an address field and
wherein the step of detecting comprises the step of:
deriving a location in said parity buffer from the address field of each detected memory transaction, and
wherein the step of generating said corresponding transactions comprises the step of:
generating said corresponding transactions to involve the derived locations in said parity memory.

7. The method of claim 3
wherein the step of writing comprises:
generating memory transactions on a first bus to transfer said user data to said cache memory wherein each memory transaction includes an address field identifying a location in said cache memory, and
wherein the step of generating corresponding transactions comprises:
deriving a corresponding address in said parity buffer from said address field in each memory transaction; and
generating corresponding transactions on a second bus to generate said parity information in said parity buffer wherein each corresponding transaction involves the derived address.

8. A RAID storage controller comprising:
an interface channel for receiving user data from a host system;
a cache memory for storing user data received over said interface channel;
a first bus coupling said interface channel and said cache memory for transferring said user data therebetween;
a parity buffer;
a parity generator coupled to said first bus for generating parity information in said parity buffer; and
a second bus coupling said parity generator to said parity buffer and to said first bus,
wherein said parity generator is operable to generate said parity information corresponding to said user data substantially in parallel with the transfer of said user data from said interface channel to said cache memory via said first bus.

9. The controller of claim 8 wherein said controller is operable to copy said parity information from said parity buffer to said cache memory following completion of the generation thereof by said parity generator.

10. The controller of claim 8 wherein said parity generator includes:
a bus monitor to detect said memory transactions on said first bus wherein said parity generator generates said parity information in accordance with each detected memory transaction.

11. The controller of claim 8 wherein said parity buffer comprises memory having a first bandwidth and wherein said ache memory comprises memory have a second bandwidth and wherein said first bandwidth is higher than said second bandwidth.

12. The controller of claim 11 wherein said parity buffer comprises SRAM memory components and wherein said cache memory comprises DRAM memory components.

13. The controller of claim 8 wherein said first bus is a PCI bus.

14. A RAID storage subsystem comprising:
a plurality of disk drives; and
a RAID storage controller coupled to said plurality of disk drives wherein said controller comprises:
cache memory for storage of user data received from a host system connected to said controller;
a parity buffer; and
a flyby parity generator coupled to said cache memory and coupled to said parity buffer for generating parity information corresponding to said user data substantially in parallel with storing of said user data in said cache memory.

15. The subsystem of claim 14 wherein said RAID controller further comprises:
a host channel interface for receiving said user data from a host system;
a first bus coupling said host channel interface to said cache memory; and
a second bus coupling said parity generator to said parity buffer,
wherein said parity generator is coupled to said first bus to monitor the transfer of user data from said host channel interface to said cache memory for purposes of generating said parity information.
